(19) United States
(12) Patent Application Publication
(10) Pub. No.: US 2026/0091481 A1
(43) Pub. Date: Apr. 2, 2026

(54) MOBILE-TO-STATIONARY PLATFORM FOR AUTONOMOUS MOBILE ROBOTS

(71) Applicant: INTEL CORPORATION, Santa Clara, CA (US)

(72) Inventor: Leobardo Emmanuel CAMPOS MACIAS, Guadalajara (MX)

(21) Appl. No.: 18/898,709

(22) Filed: Sep. 27, 2024

(51) Int. Cl. B25J 5/00; B25J 9/12; B25J 17/00

(52) U.S. Cl. CPC B25J 5/007; B25J 9/123; B25J 17/00

(57) ABSTRACT

Disclosed herein is a hybrid platform that may support a robot/manipulator arm and that may switch between a mobility mode for relocating the hybrid platform and a stationary mode for stably supporting the robot/manipulator arm. The hybrid platform includes a base frame and a wheel attached to the base frame via a movable link. The hybrid platform also includes an actuator attached to the movable link, wherein the actuator is configured to move in a first direction to reposition the movable link to set a first mode of operation of the hybrid platform (the mobility mode) and configured to move in a second direction to reposition the movable link to set a second mode of operation (the stationary mode). In the first mode of operation, the platform is supported movably on the wheel and in the second mode of operation, the platform rests stationary on the base frame.

### TECHNICAL FIELD

The disclosure relates generally to robots and in particular, to robots that may be both mobile, where the robot is able to move autonomously to different locations, and stationary, where the robot is able to stably perform stationary tasks (e.g., with its manipulator/arm).

### BACKGROUND

As robots, autonomous vehicles, other mobile machines, etc. become increasingly skilled, it becomes important for such devices to be versatile in both their mobility and the tasks that they are able to perform while stationary. Providing for both mobility and the ability to perform stationary tasks often results in tradeoffs of efficiency, energy consumption, stability, safety, etc., where the type, reliability, stability, safety, etc. of the robot in performing stationary tasks may be compromised when the robot is provided with the ability to autonomously move/relocate. This is because wheels are typically attached to the base of the robot in order to allow the robot to move/relocate. When performing a task at a fixed location, such wheels are often actively operated to counterbalance the forces associated with the task. For example, the wheel's might be actively driven, actively braked, etc. in order to compensate for the motion of a manipulator/arm so that the robot stays stationary. Such active operation of the wheels may be prone to failures, consume excessive energy, be difficult to train, be less stable, be less reliable, and/or be less durable.

### BRIEF DESCRIPTION OF THE DRAWINGS

In the drawings, like reference characters generally refer to the same parts throughout the different views. The drawings are not necessarily to scale, emphasis instead generally being placed upon illustrating the exemplary principles of the disclosure. In the following description, various exemplary aspects of the disclosure are described with reference to the following drawings, in which:

FIGS. 1A and 1B show an example sketch of a hybrid platform that is able to transition between a mobility mode and a stationary mode;

FIG. 2 illustrates an example of a hybrid platform with connections to a wheel an actuator whose linear actuations switch between modes;

FIG. 3 depicts two example views of a two-wheeled actuation unit that may be connected to a base frame to form a hybrid platform;

FIG. 4 shows two example views of a two-wheeled actuation unit that may be connected to a base frame to form a hybrid platform;

FIG. 5 illustrates two example views of a hybrid platform that incorporates two two-wheeled actuation units;

FIG. 6 depicts two example views of a hybrid platform that incorporates two two-wheeled actuation units;

FIG. 7 shows three example views of a robot attached to the top of a hybrid platform that incorporates two two-wheeled actuation units;

FIG. 8 illustrates various base frame and wheel configuration outlines of a hybrid platform that may provide switching between mobility mode and stationary mode;

FIG. 9 depicts an exemplary schematic flow diagram of a method for switching a hybrid platform from mobility mode to stationary mode.

### DESCRIPTION

The following detailed description refers to the accompanying drawings that show, by way of illustration, exemplary details and features.

The word “exemplary” is used herein to mean “serving as an example, instance, or illustration”. Any aspect or design described herein as “exemplary” is not necessarily to be construed as preferred or advantageous over other aspects or designs.

Throughout the drawings, it should be noted that like reference numbers are used to depict the same or similar elements, features, and structures, unless otherwise noted.

The phrase “at least one” and “one or more” may be understood to include a numerical quantity greater than or equal to one (e.g., one, two, three, four, [ . . . ], etc., where “[ . . . ]” means that such a series may continue to any higher number). The phrase “at least one of” with regard to a group of elements may be used herein to mean at least one element from the group consisting of the elements. For example, the phrase “at least one of” with regard to a group of elements may be used herein to mean a selection of: one of the listed elements, a plurality of one of the listed elements, a plurality of individual listed elements, or a plurality of a multiple of individual listed elements.

The words “plural” and “multiple” in the description and in the claims expressly refer to a quantity greater than one. Accordingly, any phrases explicitly invoking the aforementioned words (e.g., “plural [elements]”, “multiple [elements]”) referring to a quantity of elements expressly refers to more than one of the said elements. For instance, the phrase “a plurality” may be understood to include a numerical quantity greater than or equal to two (e.g., two, three, four, five, [ . . . ], etc., where “[ . . . ]” means that such a series may continue to any higher number).

The phrases “group (of)”, “set (of)”, “collection (of)”, “series (of)”, “sequence (of)”, “grouping (of)”, etc., in the description and in the claims, if any, refer to a quantity equal to or greater than one, i.e., one or more. The terms “proper subset”, “reduced subset”, and “lesser subset” refer to a subset of a set that is not equal to the set, illustratively, referring to a subset of a set that contains less elements than the set.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer. The term “data”, however, is not limited to the aforementioned examples and may take various forms and represent any information as understood in the art.

The terms “processor” or “controller” as, for example, used herein may be understood as any kind of technological entity that allows handling of data. The data may be handled according to one or more specific functions executed by the processor or controller. Further, a processor or controller as used herein may be understood as any kind of circuit, e.g., any kind of analog or digital circuit. A processor or a controller may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. Any other kind of implementation of the respective functions, which will be described below in further detail, may also be understood as a processor, controller, or logic circuit. It is understood that any two (or more) of the processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

As used herein, “memory” is understood as a computer-readable medium (e.g., a non-transitory computer-readable medium) in which data or information can be stored for retrieval. References to “memory” included herein may thus be understood as referring to volatile or non-volatile memory, including random access memory (RAM), read-only memory (ROM), flash memory, solid-state storage, magnetic tape, hard disk drive, optical drive, 3D XPoint™, among others, or any combination thereof. Registers, shift registers, processor registers, data buffers, among others, are also embraced herein by the term memory. The term “software” refers to any type of executable instruction, including firmware.

Unless explicitly specified, the term “transmit” encompasses both direct (point-to-point) and indirect transmission (via one or more intermediary points). Similarly, the term “receive” encompasses both direct and indirect reception. Furthermore, the terms “transmit,” “receive,” “communicate,” and other similar terms encompass both physical transmission (e.g., the transmission of radio signals) and logical transmission (e.g., the transmission of digital data over a logical software-level connection). For example, a processor or controller may transmit or receive data over a software-level connection with another processor or controller in the form of radio signals, where the physical transmission and reception is handled by radio-layer components such as RF transceivers and antennas, and the logical transmission and reception over the software-level connection is performed by the processors or controllers. The term “communicate” encompasses one or both of transmitting and receiving, i.e., unidirectional or bidirectional communication in one or both of the incoming and outgoing directions. The term “calculate” encompasses both ‘direct’ calculations via a mathematical expression/formula/relationship and ‘indirect’ calculations via lookup or hash tables and other array indexing or searching operations.

A “vehicle” may be understood to include any type of machinery that may be operated by software, including autonomous, partially autonomous, stationary, moving, or other objects or entities that utilize software as part of their operation. By way of example, a vehicle may be a driven object with a combustion engine, a reaction engine, an electrically driven object, a hybrid driven object, or a combination thereof. A vehicle may be or may include an automobile, a bus, a mini bus, a van, a truck, a mobile home, a vehicle trailer, a motorcycle, a bicycle, a tricycle, a train locomotive, a train wagon, a robot, a personal transporter, a boat, a ship, a submersible, a submarine, a drone, an aircraft, industrial machinery, autonomous or partially autonomous machinery, or a rocket, among others.

A “robot” may be understood to include any type of digitally controllable machine that is designed to perform a task or tasks. By way of example, a robot may be an autonomous mobile robot (AMR) that may move within an area (e.g., a manufacturing floor, an office building, a warehouse, etc.) to perform a task or tasks; or a robot may be understood as an automated machine with arms, tools, and/or sensors that may perform a task or tasks at a fixed location; or a combination thereof. More generally, “vehicle” and “robot” may be used herein to refer to devices that utilize sensor information about the environment to inform operation of the vehicle/robot with respect to the environment. Such vehicles and robots may be referred to as an “autonomous agent.”

As noted above, a robot that is both mobile and able to perform stationary tasks may result in tradeoffs of efficiency, energy consumption, stability, safety, etc., where the type, reliability, stability, safety, etc. of the robot in performing stationary tasks may be compromised when the robot is provided with the ability to autonomously move/relocate. If wheels are used to provide mobility to the robot, the wheels may need to be actively operated to counterbalance the forces associated with the task. For example, the wheel(s) of the robot may be actively driven, actively braked, etc. in order to continuously and dynamically compensate for the motion of a manipulator/arm so that the robot stays stationary. Such an active and dynamic compensation system requires complex sensing and processing in order to dynamically adjust for the changing forces. In addition, such active operation may be prone to sensor failures, calculation errors, estimation errors, etc., may consume excessive energy, may be difficult to predict/train, may be less stable, may be less reliable, and/or may be less durable, leading to higher maintenance/replacement costs. In addition, wheels may have less friction with the floor, meaning that they may not be able to support the same level of counterforces generated when performing tasks as would otherwise be possible with a fixed frame.

The hybrid platform disclosed in more detail below may not suffer from such problems because the platform is able to transform from having the wheels contact the floor into a stable platform where a base frame-rather than wheels-contacts the floor. In this manner, the stability of the platform does not depend on the wheels and instead depends on the shape of the platform's frame and its contact with the floor. For example, when in stationary mode, the entire base frame may contact the ground, providing a convex hull that may provide greater stability then wheels. In mobility mode, the wheels may contact the ground, lifting the base frame away from its contact with the ground, providing mobility via the wheels.

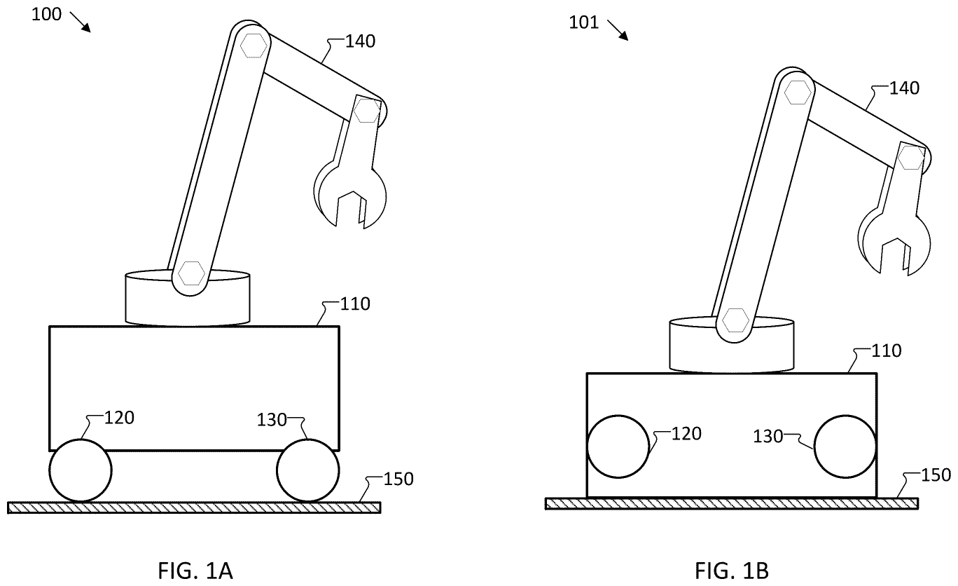

FIGS. 1A-1B show example sketches of robot in a mobility mode 100 (in FIG. 1A) and in a stationary mode 101 (in FIG. 1B). The robot includes a robot/manipulator arm 140 that may be attached to a base frame 110. Wheels 120 and 130 are movably attached to the base frame 110. In mobility mode 100, wheels 120 and 130 are moved with respect to the base from 110 so that they are below the bottom of the base frame 110 so as to contact the surface of the floor 150. Thus, the base frame 110 is lifted away from floor 150 so that it does not contact the floor 150, allowing wheels 120 and 130 to contact floor 150 to move the robot.

In stationary mode 101, wheels 120 and 130 are moved with respect to the base frame 110 so that they are above the bottom of the base frame 110 and so that the base frame 110 contacts the surface of the floor 150. Thus, the base frame 110 rests on floor 150, while the wheels 120 and 130 are away lifted away from the floor 150. In stationary mode 101, the base frame 110 may provide a stable base for the robot/manipulator arm 140 to perform tasks while it is stationary. As should be appreciated, FIGS. 1A and 1B show merely a simplified example of a hybrid platform, and any shape of base frame (e.g., base frame 110) and any number of wheels (e.g., wheels 120, 130) may be used, depending on the intended task, operating environment, manipulator/arm, expected movements, etc. As will be explained, an actuator (e.g., a linear actuator) in combination with various pivot arms (not shown in FIGS. 1A/1B) may be used to connect wheels 120, 130 to the base frame 110 and provide relative movement between base frame 110 and wheels 120, 130 (e.g., through a linear actuation).

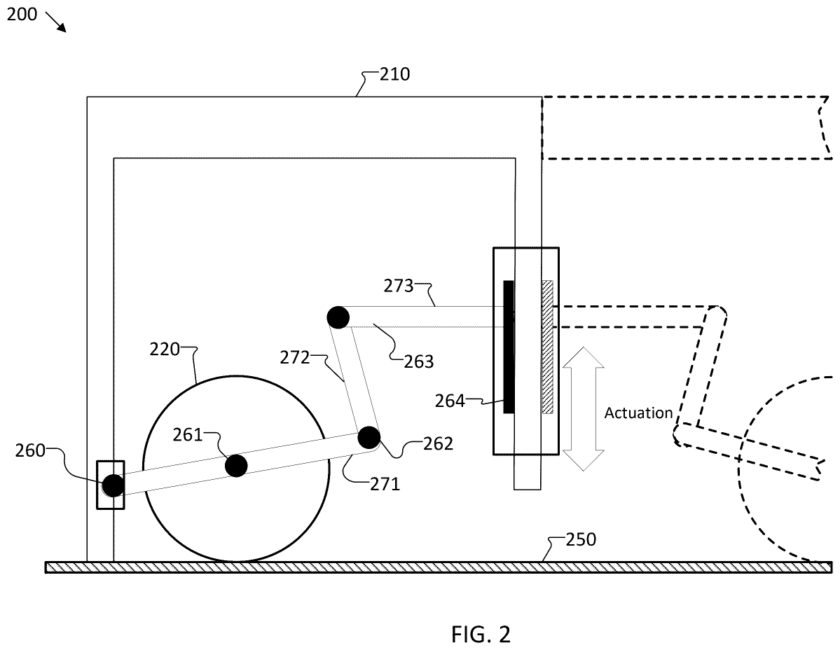

FIG. 2 shows an example view 200 of how wheel(s) may be connected through various pivot arms to the base frame, where the pivot arms may be moved by an actuator to provide relative movement between the base frame and the wheels. The shape of the platform and the number of wheels on the disclosed hybrid platform may vary, depending on the intended use of the robot, for example. In the example of FIG. 2, a lateral arm 273 may be fixedly connected to an actuator that slides the lateral arm 273 up and down along a sliding connection 264. This movement lowers or raises the lateral arm 273 with respect to the base frame 210 and, through the series of arms (272, 271) attached by joints (263, 262, 261, 260), moves wheel 220 correspondingly up and down with respect to the base frame 210. To provide this motion, arm 271 may be fixedly attached via a pivoting joint 260 at base frame 210. By lowering lateral arm 273 linearly along sliding connection 264, wheel 220 is lowered with respect to base frame 210, raising the base frame 210 with respect to the wheel 220 so that wheel 220 contacts floor 250 to provide a mobility mode. By raising lateral arm 273 linearly along sliding connection 264, wheel 220 raise with respect to base frame 210, lowering the base frame 210 with respect to the wheel 220 so that base frame 210 contacts floor 250 to provide a stationary mode.

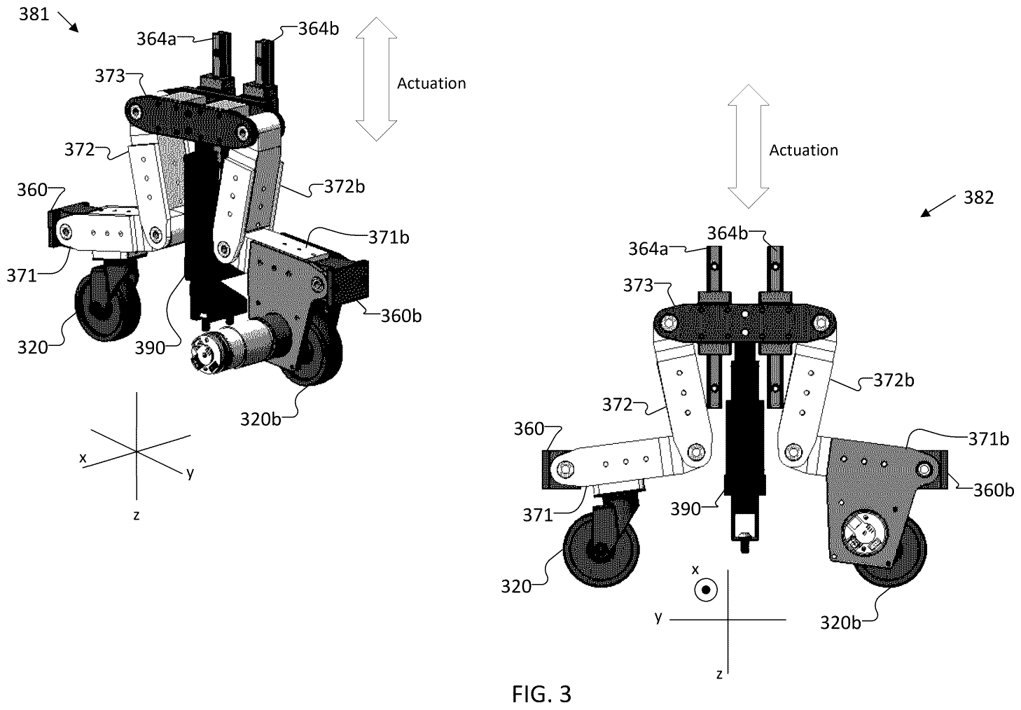

In FIG. 2, only a single wheel is annotated, but it should be appreciated that a mirrored set of arms and joints my attach to an additional wheel, as indicated by the incomplete and unannotated set of dashed lines on the right side of FIG. 2. In this sense, lateral arm 273 may be a continuous arm that is fixedly connected to the actuator to provide linear, vertical sliding motion along sliding connection 264. A more detailed example of this type of two-wheeled actuation unit is shown in FIG. 3, which shows an angled view 381 of a two-wheeled actuation unit (along the x-axis, y-axis, and z-axis as shown) and a lateral view 382 (looking into the x-axis and along the y-axis and z-axis as shown) of the two-wheeled actuation unit.

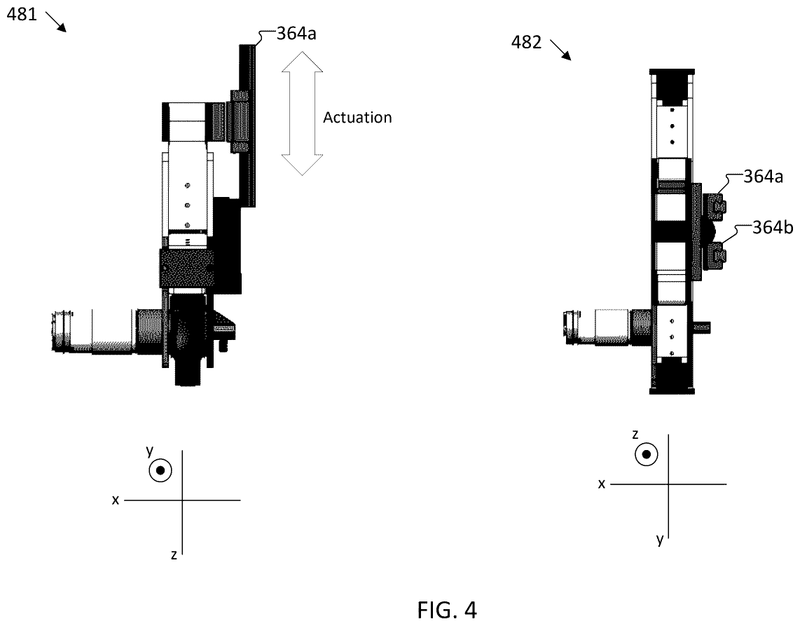

Actuator 390 provides linear motion (up and down, as shown by the actuation arrows) of the lateral arm 373 along sliding connections 364a/364b. The actuator 390 is fixedly connected to lateral arm 373 so that it may slide up and down with respect to the sliding connections 364a/356b, which are fixedly attached to the base frame (not shown in FIG. 3). Lateral arm 373 connects to the wheel 320 through link 372 and link 371, where link 371 is fixedly attached to the base frame at a pivoting joint 360 that allows link 371 to pivot at pivoting joint 360 with respect to the base frame. Mirrored on the other side, lateral arm 373 connects to wheel 320b through link 372b and link 371b, where link 371b is fixedly attached to the base frame at a pivoting joint 360b that allows link 371b to pivot at pivoting joint 360b with respect to the base frame. FIG. 4 shows a side view 481 and a top view 482 of the two-wheeled actuation unit of FIG. 3, where the side view 481 is looking into the y-axis and along the x-axis and z-axis, whereas top view 482 is looking in to the z-axis and along the x-axis and y-axis. As can be seen in side view 481, one of the sliding connections (e.g., sliding connection 364a) provides for linear actuation along the z-axis when actuated by the actuator to change modes between the stationary mode and the mobility mode. In top view 482, two sliding connections (e.g., sliding connection 364a, 364b) can be see that provide for linear actuation along the z-axis (in/out of the page) when actuated by the actuator.

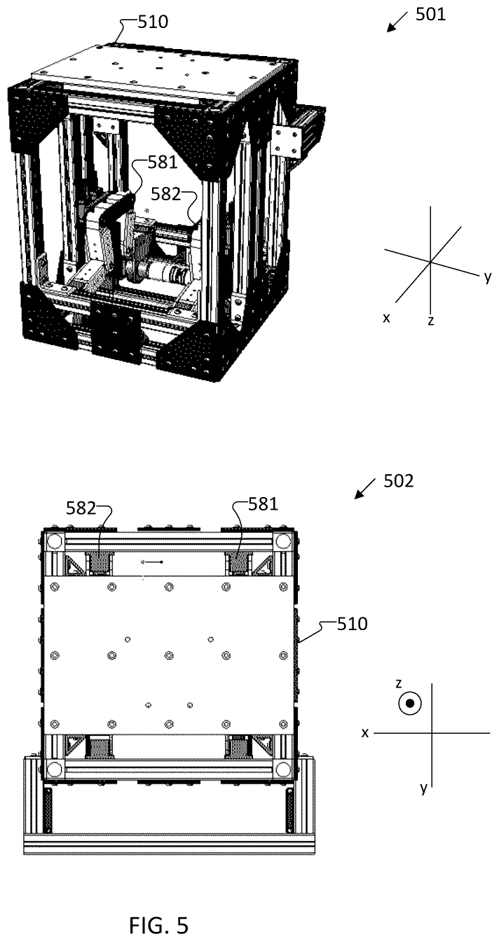

FIG. 5 shows views of an example of a hybrid platform that includes a base frame 510 attached to two two-wheeled actuation units of FIG. 3 (a first two-wheeled actuation unit 581 and a second two-wheeled actuation unit 582), where the first view is an angled view 501 and the second view is top view 502 looking into the z-axis. The hybrid platform of FIG. 5 may accommodate a robot/manipulator arm (not shown) that may be attached to the top plate of the base frame 510. The rectangular shape of the bottom of the base frame 510 provides a stable base for the attached robot/manipulator arm that sturdily contacts the floor in stationary mode. When switched into mobility mode, the platform is able to move the robot/manipulator arm to a new location, where it may, for example, switch back to stationary mode to perform a task. The switching between mobility mode and stationary mode is achieved by actuation (e.g., linear actuation) of the two-wheeled actuation units so that either the wheels are contacting the floor (in mobility mode) or the base frame 510 (in stationary mode).

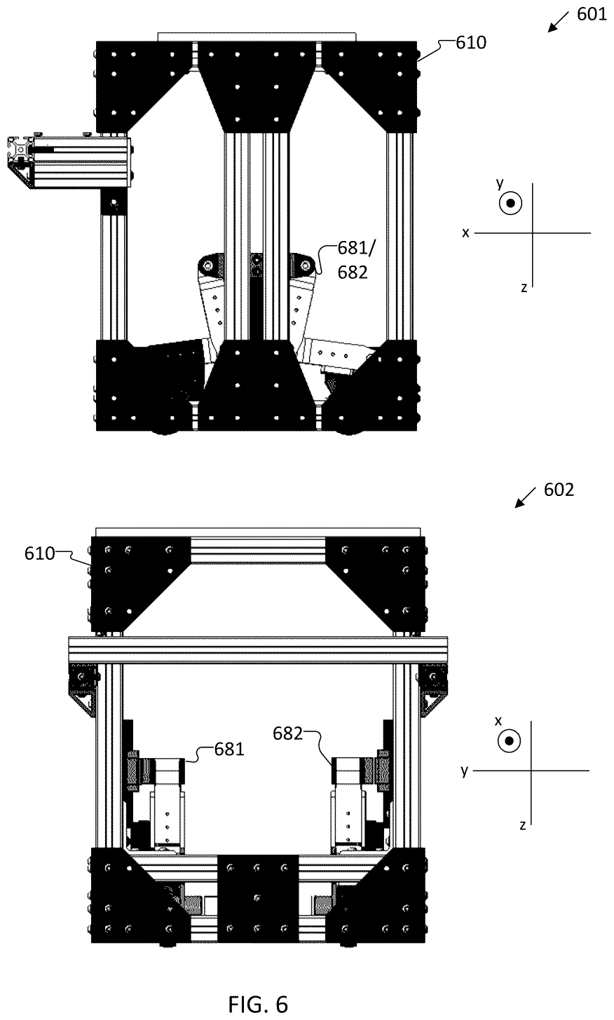

FIG. 6 shows two additional views of the hybrid platform of FIG. 5 that also includes a base frame 610 attached to two two-wheeled actuation units (two-wheeled actuation unit 681 and two-wheeled actuation unit 682). The first view is a first side view 601 that looks into the y-axis, so only one of the two two-wheeled actuation units 681/682 can be seed. The second view is a second side view 602 that looks into the x-axis, so both two-wheeled actuation unit 681 and two-wheeled actuation unit 682 can be seen.

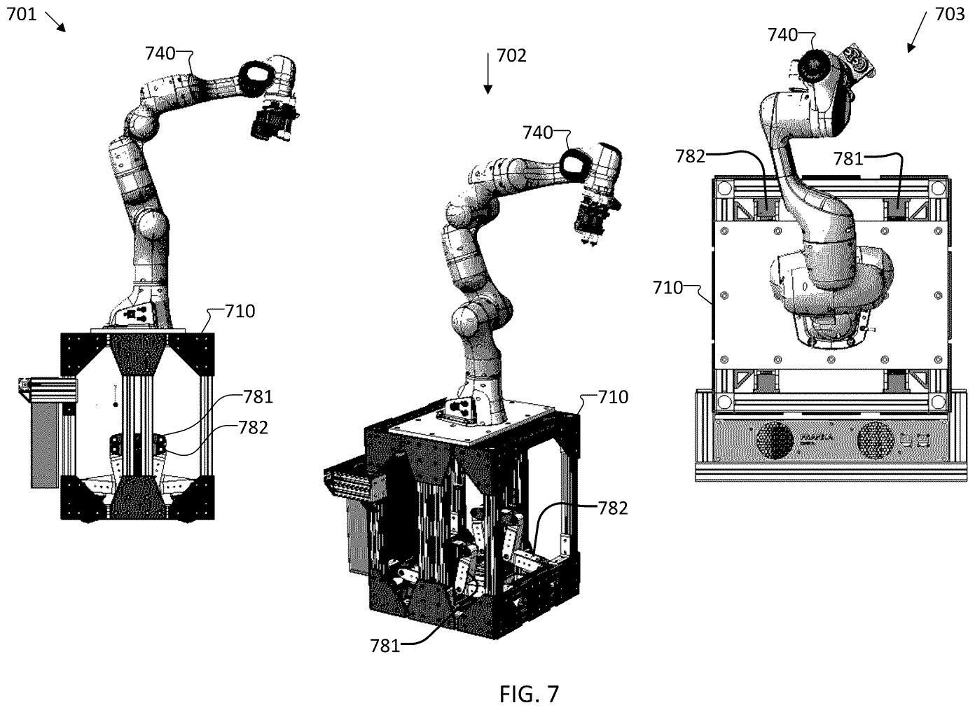

FIG. 6 shows three views of the hybrid platform of FIG. 5 with a robot/manipulator arm 740 attached to the top of base frame 710, where base frame 710 has two two-wheeled actuation units (two-wheeled actuation unit 781 and two-wheeled actuation unit 782). View 701 is a side view of the hybrid platform, view 702 is an angled side view of the hybrid platform, and view 703 is a top view of the hybrid platform. As should be understood, robot/manipulator arm 740 is merely exemplary, and any type of robot/manipulator arm may be attached to the base frame 710. As should be appreciated, while FIGS. 3-7 focus on two-wheeled actuation units, as explained earlier, the linearly actuated unit may be for a single wheel.

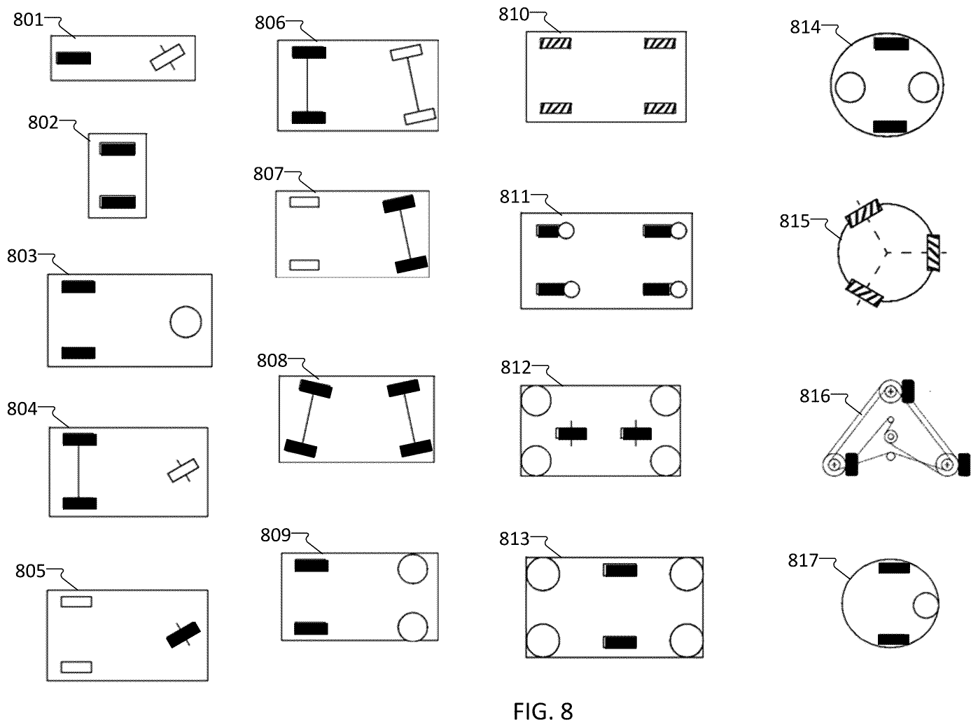

FIG. 8 shows example hybrid platform design outlines (top view) for the base frames and wheel configurations to which the linearly actuated wheel mechanisms described above may be applied in order to provide a hybrid platform that may convert between a stationary mode and a mobility mode. Wheels that are shaded black or striped indicate a motorized wheel. As should be appreciated, these outlines are only examples, and the linearly actuated wheel mechanisms described above may be applied to any type of configuration of the hybrid platform. As should also be appreciated, while the hybrid platform designs shown in FIG. 8 have base frames where the wheels are generally within the outer outline of the platform (e.g., the wheels are within the contact points/external surface of the base frame) to maintain a compact design, other configurations may also be used where one or more wheels are outside the outline of the platform.

The table below briefly describes, for each hybrid platform design outline indicated in FIG. 8, the type of drive system that might be used.

| Number | Description |
|---|---|
| 801 | One steering wheel in the front, one traction wheel in the rear |
| 802 | Two-wheel differential drive with the center of mass below the axle |
| 803 | Two independently driven wheels in the rear/front, 1 unpowered |
| | omnidirectional wheel in the front/rear |
| 804 | Two connected traction wheels (differential) in the rear, 1 steered free wheel |
| | in the front |
| 805 | Two free wheels in the rear, 1 steered traction wheel in the front |
| 806 | Two motorized wheels in the rear and 2 steered wheels in the front; steering |
| | must be different for the 2 wheels to avoid slipping/skidding |
| 807 | Two motorized and steering wheels in the front and 2 free wheels in the rear; |
| | steering must be different for the 2 wheels to avoid slipping/skidding |
| 808 | Four steered and motorized wheels |
| 809 | Two traction wheels (differential) in the rear/front, 2 omnidirectional wheels |
| | in the front/rear |
| 810 | Four omnidirectional wheels |
| 811 | Four motorized and steered castor wheels |
| 812 | Two motorized and steered wheels aligned in the center, 1 omnidirectional |
| | wheel at each corner |
| 813 | Two traction wheels (differential) in the center, 1 omnidirectional wheel at |
| | each corner |
| 814 | Two-wheel differential drive with 2 additional points of contact |
| 815 | Three motorized Swedish or spherical wheels arranged in a triangle; |
| | omnidirectional movement is possible |
| 816 | Three synchronously motorized and steered wheels; the orientation is not |
| | controllable |
| 817 | Two-wheel centered differential drive with a third point of contact |

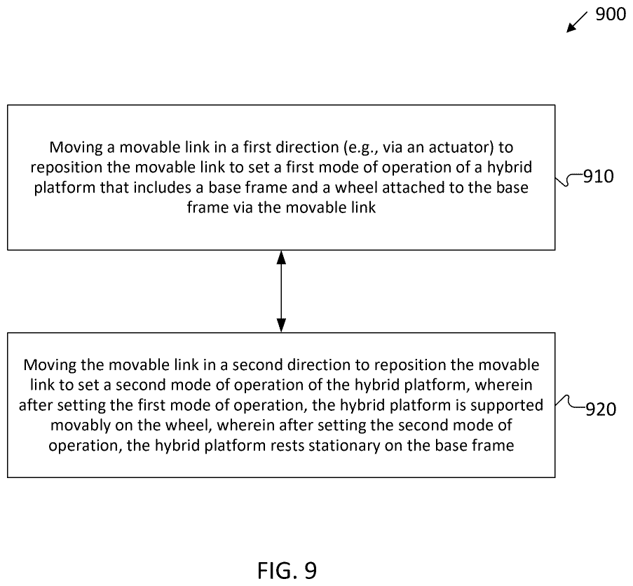

FIG. 9 depicts a schematic flow diagram of a method 900 for operating a hybrid platform to support a robot on a base frame that includes a wheel attached to the base frame via a movable link. Method 900 includes, in 910, moving a movable link in a first direction (e.g., via an actuator) to reposition the movable link to set a first mode of operation of a hybrid platform that includes a base frame and a wheel attached to the base frame via the movable link. Method 900 includes, in 920, moving the movable link in a second direction to reposition the movable link to set a second mode of operation of the hybrid platform, wherein after setting the first mode of operation, the hybrid platform is supported movably on the wheel, wherein after setting the second mode of operation, the hybrid platform rests stationary on the base frame (e.g., with respect to the floor, ground, environment, etc.).

In the following, various examples are provided that may include one or more aspects described with reference to the trust platforms discussed above and/or any of FIGS. 1-9. The examples provided in relation to the devices may apply also to the described method(s), and vice versa.

Example 1 is a device (e.g., a platform for supporting a robot/manipulator arm) that includes a base frame and a wheel attached to the base frame via a movable link. The device also includes an actuator attached to the movable link, wherein the actuator is configured to move in a first direction to reposition the movable link to set a first mode of operation of the device and configured to move in a second direction to reposition the movable link to set a second mode of operation of the device, wherein in the first mode of operation, the device is supported movably on the wheel, wherein in the second mode of operation, the device rests stationary on the base frame (e.g., with respect to the floor, ground, environment, etc.).

Example 2 is the device of example 1, wherein the base frame includes a surface for fixedly attaching a robot to the base frame.

Example 3 is the device of any one of examples 1 to 2, wherein the actuator is a linear actuator and the first direction is linearly opposite to the second direction.

Example 4 is the device of any one of examples 1 to 3, wherein the first mode of operation includes a mobility mode, wherein in the mobility mode the device is movable via the wheel, wherein the second mode of operation includes a stationary mode, wherein in the stationary mode the device rests on a plane defined by a base of the base frame.

Example 5 is the device of any one of examples 1 to 4, wherein the movable link includes a series of moveable links connected together via pivotable joints.

Example 6 is the device of example 5, wherein the series of movable links include a first link, a second link, and a third link, wherein the first link is slidably attached to the base frame and pivotably attached to the second link, wherein the third link is pivotably attached to the base frame and pivotably attached to the second link, wherein the wheel is rotatably attached to the third link.

Example 7 is the device of example 6, wherein the first link is slidable along the base frame in the first direction and second directions, wherein when the first link is slid in the first direction, the wheel is lowered with respect to a plane defined by a base of the base frame, wherein when the first link is slid in the second direction, the wheel is raised with respect to the plane.

Example 8 is the device of any one of examples 6 to 7, the device including a second wheel, wherein the series of movable links further include a fourth link and a fifth link, wherein the second wheel is rotatably attached to the fifth link, wherein the fourth link is pivotably attached to the first link and pivotably attached to the fifth link.

Example 9 is the device of example 8, wherein when the first link is slid in the first direction, the second wheel is lowered with respect to a plane defined by a base of the base frame, wherein when the first link is slid in the second direction, the second wheel is raised with respect to the plane.

Example 10 is the device of any one of examples 8 to 9, wherein in the first mode of operation, the device is also supported movably on the second wheel.

Example 11 is the device of any one of examples 1 to 10, wherein the wheel is located within an outer perimeter of the device defined by the base frame.

Example 12 is a system including a platform and a robot that is attached to the platform, wherein the platform is convertible between a mobility mode and a stationary mode. The platform includes a base frame and a wheel attached to the base frame via a movable link. The platform also includes an actuator attached to the movable link, wherein the actuator is configured to move in a first direction to reposition the movable link to convert the platform into the mobility mode and configured to move in a second direction to reposition the movable link to convert the platform into the stationary mode of operation, wherein in the mobility mode, the platform is supported movably on the wheel, wherein in the stationary mode, the platform rests stationary on the base frame (e.g., with respect to the floor, ground, environment, etc.).

Example 13 is the system of example 12, wherein the base frame includes a surface on which the robot is fixedly attached to the base frame.

Example 14 is the system of any one of examples 12 to 13, wherein the actuator is a linear actuator and the first direction is linearly opposite to the second direction.

Example 15 is the system of any one of examples 12 to 14, wherein in the mobility mode the platform is movable via the wheel, wherein in the stationary mode, the platform rests on a plane defined by a base of the base frame.

Example 16 is the system of any one of examples 12 to 15, wherein the movable link includes a series of moveable links connected together via pivotable joints.

Example 17 is the system of example 16, wherein the series of movable links include a first link, a second link, and a third link, wherein the first link is slidably attached to the base frame and pivotably attached to the second link, wherein the third link is pivotably attached to the base frame and pivotably attached to the second link, wherein the wheel is rotatably attached to the third link.

Example 18 is the system of example 17, wherein the first link is slidable along the base frame in the first direction and second directions, wherein when the first link is slid in the first direction, the wheel is lowered with respect to a plane defined by a base of the base frame, wherein when the first link is slid in the second direction, the wheel is raised with respect to the plane.

Example 19 is the system of any one of examples 17 to 18, the platform including a second wheel, wherein the series of movable links further include a fourth link and a fifth link, wherein the second wheel is rotatably attached to the fifth link, wherein the fourth link is pivotably attached to the first link and pivotably attached to the fifth link.

Example 20 is the system of example 19, wherein when the first link is slid in the first direction, the second wheel is lowered with respect to a plane defined by a base of the base frame, wherein when the first link is slid in the second direction, the second wheel is raised with respect to the plane.

Example 21 is the system of any one of examples 19 to 20, wherein in the first mode of operation, the platform is also supported movably on the second wheel.

Example 22 is the system of any one of examples 12 to 21, wherein the wheel is located within an outer perimeter of the platform defined by the base frame.

Example 23 is a method for operating a hybrid platform to support a robot on a base frame that includes a wheel attached to the base frame via a movable link. The method includes moving the movable link in a first direction (via an actuator) to reposition the movable link to set a first mode of operation of the hybrid platform or moving the movable link in a second direction to reposition the movable link to set a second mode of operation of the hybrid platform, wherein after setting the first mode of operation, the hybrid platform is supported movably on the wheel, wherein after setting the second mode of operation, the hybrid platform rests stationary on the base frame (e.g., with respect to the floor, ground, environment, etc.).

Example 24 is the method of example 23, the method further including fixedly attaching the robot to the base frame (e.g., on a surface thereof).

Example 25 is the method of any one of examples 23 to 24, wherein moving the movable link includes moving linearly along the first direction and the second direction (e.g., where the first direction and second direction are along the same linear extent).

Example 26 is the method of any one of examples 23 to 25, wherein the first mode of operation includes a mobility mode, wherein after the hybrid platform is set in the mobility mode, the method further includes moving the hybrid platform via the wheel, wherein the second mode of operation includes a stationary mode, wherein after the hybrid platform is set in the stationary mode, the method further includes resting the hybrid platform on a plane defined by a base of the base frame.

Example 27 is the method of any one of examples 23 to 26, wherein the movable link includes a series of moveable links connected together via pivotable joints.

Example 28 is the method of example 27, wherein the series of movable links include a first link, a second link, and a third link, wherein the first link is slidably attached to the base frame and pivotably attached to the second link, wherein the third link is pivotably attached to the base frame and pivotably attached to the second link, wherein the wheel is rotatably attached to the third link.

Example 29 is the method of example 28, wherein the first link is slidable along the base frame in the first direction and second directions, the method further including: sliding, to set the first mode of operation, the first link in the first direction to lower the wheel with respect to a plane defined by a base of the base frame; or sliding, to set the second mode of operation, the first link in the second direction to raise the wheel with respect to the plane.

Example 30 is the method of any one of examples 28 to 29, wherein the series of movable links further include a fourth link and a fifth link, wherein a second wheel is rotatably attached to the fifth link, wherein the fourth link is pivotably attached to the first link and pivotably attached to the fifth link.

Example 31 is the method of example 30, the method further including: sliding the first link in the first direction to lower the second wheel with respect to a plane defined by a base of the base frame; or sliding the first link in the second direction to raise the second wheel with respect to the plane.

Example 32 is the method of any one of examples 30 to 31, wherein after setting the first mode of operation, the hybrid platform is also supported movably on the second wheel.

Example 33 is the method of any one of examples 23 to 32, wherein the wheel is located within an outer perimeter of the hybrid platform defined by the base frame.

Example 34 is an apparatus including a supporting means (e.g., a base frame) capable of attaching a robot/manipulator arm thereto) and a means for enabling movement (e.g., a wheel) attached to the supporting means via a movable means for linking (e.g., a link). The apparatus also includes an actuating means attached to the movable means for linking, wherein the actuating means is configured to move in a first direction to reposition the movable means for linking to set a first mode of operation of the apparatus and configured to move in a second direction to reposition the movable means for linking to set a second mode of operation of the apparatus, wherein in the first mode of operation, the apparatus is supported movably on the means for enabling movement, wherein in the second mode of operation, the apparatus rests stationary on the supporting means (e.g., with respect to the floor, ground, environment, etc.).

Example 35 is the apparatus of example 34, wherein the supporting means includes a surface for fixedly attaching a robot to the supporting means.

Example 36 is the apparatus of any one of examples 34 to 35, wherein the actuating means is a linear actuating means and the first direction is linearly opposite to the second direction.

Example 37 is the apparatus of any one of examples 34 to 36, wherein the first mode of operation includes a mobility mode, wherein in the mobility mode the apparatus is movable via the means for enabling movement, wherein the second mode of operation includes a stationary mode, wherein in the stationary mode the apparatus rests on a plane defined by a base of the supporting means.

Example 38 is the apparatus of any one of examples 34 to 37, wherein the movable means for linking includes a series of moveable means for linking connected together via one or more means for pivotably joining the means for linking.

Example 39 is the apparatus of example 38, wherein the series of movable means for linking include a first means for linking, a second means for linking, and a third means for linking, wherein the first means for linking is slidably attached to the supporting means and pivotably attached to the second means for linking, wherein the third means for linking is pivotably attached to the supporting means and pivotably attached to the second means for linking, wherein the means for enabling movement is rotatably attached to the third means for linking.

Example 40 is the apparatus of example 39, wherein the first means for linking is slidable along the supporting means in the first direction and second directions, wherein when the first means for linking is slid in the first direction, the means for enabling movement is lowered with respect to a plane defined by a base of the supporting means, wherein when the first means for linking is slid in the second direction, the means for enabling movement is raised with respect to the plane.

Example 41 is the apparatus of any one of examples 39 to 40, the apparatus including a second means for enabling movement, wherein the series of movable means of linking further include a fourth means for linking and a fifth means for linking, wherein the second means for enabling movement is rotatably attached to the fifth means for linking, wherein the fourth means for linking is pivotably attached to the first means for linking and pivotably attached to the fifth means for linking.

Example 42 is the apparatus of example 41, wherein when the first means for linking is slid in the first direction, the second means for enabling movement is lowered with respect to a plane defined by a base of the supporting means, wherein when the first means for linking is slid in the second direction, the second means for enabling movement is raised with respect to the plane.

Example 43 is the apparatus of any one of examples 41 to 42, wherein in the first mode of operation, the apparatus is also supported movably on the second means for enabling movement.

Example 44 is the apparatus of any one of examples 34 to 43, wherein the means for enabling movement is located within an outer perimeter of the apparatus defined by the supporting means.

While the disclosure has been particularly shown and described with reference to specific aspects, it should be understood by those skilled in the art that various changes in form and detail may be made therein without departing from the spirit and scope of the disclosure as defined by the appended claims. The scope of the disclosure is thus indicated by the appended claims and all changes, which come within the meaning and range of equivalency of the claims, are therefore intended to be embraced.

Claimed is:

1. A device comprising:
a base frame;
a wheel attached to the base frame via a movable link; and
an actuator attached to the movable link, wherein the actuator is configured to move in a first direction to reposition the movable link to set a first mode of operation of the device and configured to move in a second direction to reposition the movable link to set a second mode of operation of the device, wherein in the first mode of operation, the device is supported movably on the wheel, wherein in the second mode of operation, the device rests stationary on the base frame.

2. The device of claim 1, wherein the base frame comprises a surface for fixedly attaching a robot to the base frame.

3. The device of claim 1, wherein the actuator is a linear actuator and the first direction is linearly opposite to the second direction.

4. The device of claim 1, wherein the first mode of operation comprises a mobility mode, wherein in the mobility mode the device is movable via the wheel, wherein the second mode of operation comprises a stationary mode, wherein in the stationary mode the device rests on a plane defined by a base of the base frame.

5. The device of claim 1, wherein the movable link comprises a series of moveable links connected together via pivotable joints.

6. The device of claim 5, wherein the series of movable links comprise a first link, a second link, and a third link, wherein the first link is slidably attached to the base frame and pivotably attached to the second link, wherein the third link is pivotably attached to the base frame and pivotably attached to the second link, wherein the wheel is rotatably attached to the third link.

7. The device of claim 6, wherein the first link is slidable along the base frame in the first direction and the second direction, wherein when the first link is slid in the first direction, the wheel is lowered with respect to a plane defined by a base of the base frame, wherein when the first link is slid in the second direction, the wheel is raised with respect to the plane.

8. The device of claim 6, the device comprising a second wheel, wherein the series of movable links further comprise a fourth link and a fifth link, wherein the second wheel is rotatably attached to the fifth link, wherein the fourth link is pivotably attached to the first link and pivotably attached to the fifth link.

9. The device of claim 8, wherein when the first link is slid in the first direction, the second wheel is lowered with respect to a plane defined by a base of the base frame, wherein when the first link is slid in the second direction, the second wheel is raised with respect to the plane.

10. The device of claim 8, wherein in the first mode of operation, the device is also supported movably on the second wheel.

11. The device of claim 1, wherein the wheel is located within an outer perimeter of the device defined by the base frame.

12. A system comprising:
a platform; and
a robot that is attached to the platform, wherein the platform is convertible between a mobility mode and a stationary mode, wherein the platform comprises:
a base frame;
a wheel attached to the base frame via a movable link; and
an actuator attached to the movable link, wherein the actuator is configured to move in a first direction to reposition the movable link to convert the platform into the mobility mode and configured to move in a second direction to reposition the movable link to convert the platform into the stationary mode of operation, wherein in the mobility mode, the platform is supported movably on the wheel, wherein in the stationary mode, the platform rests stationary on the base frame.

13. The system of claim 12, wherein the actuator is a linear actuator and the first direction is linearly opposite to the second direction.

14. The system of claim 12, wherein the movable link comprises a series of moveable links connected together via pivotable joints.

15. The system of claim 14, wherein the series of movable links comprise a first link, a second link, and a third link, wherein the first link is slidably attached to the base frame and pivotably attached to the second link, wherein the third link is pivotably attached to the base frame and pivotably attached to the second link, wherein the wheel is rotatably attached to the third link.

16. The system of claim 15, wherein the first link is slidable along the base frame in the first direction and the second direction, wherein when the first link is slid in the first direction, the wheel is lowered with respect to a plane defined by a base of the base frame, wherein when the first link is slid in the second direction, the wheel is raised with respect to the plane.

17. The system of claim 15, the platform comprising a second wheel, wherein the series of movable links further comprise a fourth link and a fifth link, wherein the second wheel is rotatably attached to the fifth link, wherein the fourth link is pivotably attached to the first link and pivotably attached to the fifth link.

18. The system of claim 17, wherein when the first link is slid in the first direction, the second wheel is lowered with respect to a plane defined by a base of the base frame, wherein when the first link is slid in the second direction, the second wheel is raised with respect to the plane.

19. An apparatus comprising:
a supporting means to which a robot may be fixedly attached;
a means for enabling movement that is attached to the supporting means via a movable means for linking; and
an actuating means attached to the movable means for linking, wherein the actuating means is configured to move in a first direction to reposition the movable means for linking to set a first mode of operation of the apparatus and configured to move in a second direction to reposition the movable means for linking to set a second mode of operation of the apparatus, wherein in the first mode of operation, the apparatus is supported movably on the means for enabling movement, wherein in the second mode of operation, the apparatus rests stationary on the supporting means.

20. The apparatus of claim 19, wherein the actuating means comprises a linear actuating means and the first direction is linearly opposite to the second direction.
